(19) United States
(12) Patent Application Publication
(10) Pub. No.: US 2024/0015700 A1
(43) Pub. Date: Jan. 11, 2024

(54) METHOD FOR MULTI-PAGING OF USER EQUIPMENT

(71) Applicant: MediaTek Singapore Pte. Ltd., Singapore (SG)

(72) Inventors: Hung-Yueh CHEN, Seongnam-si (KR); Hung-Wei SHIH, Hsinchu City (TW); Byeng Hyun Kim, Seongnam-si (KR); JUNG SHUP SHIN, Seongnam-si (KR); Kyung Hyun Ahn, Seongnam-si (KR); Amit Kumar Shukla, Uttar Pradesh (IN)

(21) Appl. No.: 18/299,165

(22) Filed: Apr. 12, 2023

(30) Foreign Application Priority Data
Jul. 8, 2022 (IN) 202221039398

(51) Int. Cl. H04W 68/06; H04W 68/02; H04W 72/542

(52) U.S. Cl. CPC H04W 68/06; H04W 68/02; H04W 72/542

(57) ABSTRACT

The invention provides a method for multi-paging of a user equipment (UE) in a network; the network may be a wireless cellular network, and may comprise a plurality of cells. The method may be executed by the UE, and may comprise a multi-paging procedure. The multi-paging procedure may comprise: when the UE camps on a serving cell of the plurality of cells, checking whether a non-serving cell paging message is received on a non-serving cell of the plurality of cells, with the non-serving cell being different from the serving cell.

This application claims the benefit of India provisional patent application Serial No. 202221039398, filed Jul. 8, 2022, the subject matter of which is incorporated herein by reference.

### FIELD OF THE INVENTION

The present invention relates to a method for multi-paging of a user equipment (UE) in a network, and more particularly, to a method by which the UE may check (monitor) whether a non-serving cell paging message is received on a non-serving cell different from a serving cell which the UE currently camps on; if received, the UE may determine whether to respond the non-serving cell paging message on the non-serving cell according to whether a serving-cell paging message is received on the serving cell during a waiting period after receiving the non-serving cell paging message, and/or, whether one or more signal quality values of the non-serving cell meet at least one quality requirement; the UE may therefore reduce paging latency and paging miss rate.

### BACKGROUND OF THE INVENTION

User equipment (UE) to be utilized in a wireless network is prevailing in many aspects of modern daily life. How to ensure that a UE, especially a moving UE, can promptly receive and respond paging of the network when the network attempts to communicatively reach the UE is important for development of UE.

### SUMMARY OF THE INVENTION

An aspect of the invention is providing a method (e.g., 200a, 200b or 200c in FIG. 2a, 2b or 2c) for multi-paging of a user equipment (UE, e.g., 100 in FIG. 1) in a network (e.g., 10 in FIG. 1). The network may be a wireless cellular network, and may comprise a plurality of cells (e.g., c1 to c3 in FIG. 1). The method may be executed by the UE, and may comprise a multi-paging procedure (e.g., 300a or 300b in FIG. 3a or 3b). The multi-paging procedure may comprise: when the UE camps on a serving cell (e.g., c2 in FIG. 1) of the plurality of cells, checking whether a non-serving cell paging message is received on a non-serving cell (e.g., c1 in FIG. 1) of the plurality of cells (e.g., at step 302 in FIG. 3a or 3b), with the non-serving cell being different from the serving cell.

In an embodiment (e.g., 300a in FIG. 3a), the multi-paging procedure may further comprise: if the non-serving cell paging message is received on the non-serving cell, checking whether a serving-cell paging message is received on the serving cell (e.g., at step 304 in FIG. 3a).

In an embodiment (e.g., 300a in FIG. 3a), wherein when checking whether the serving-cell paging message is received on the serving cell, checking whether the serving-cell paging message is received on the serving cell during a waiting period (e.g., T_wait in FIG. 3a or 4).

In an embodiment (e.g., 300a in FIG. 3a), the waiting period may not be shorter than a discontinuous reception (DRX) cycle of the serving cell.

In an embodiment (e.g., 300a in FIG. 3a), the waiting period may not be shorter than a DRX cycle of the serving cell and a DRX cycle of the non-serving cell.

In an embodiment (e.g., 300a in FIG. 3a), the multi-paging procedure may further comprise: if the serving-cell paging message is received on the serving cell (e.g., at step 304), responding the serving-cell paging message on the serving cell (e.g., at step 314).

In an embodiment (e.g., 300a in FIG. 3a), the multi-paging procedure may further comprise: if the serving-cell paging is not received on the serving cell (e.g., during the waiting period), comparing whether one or more signal quality values of the non-serving cell meets at least one quality requirement (e.g., at step 306 in FIG. 3a); and, if the one or more signal quality values of the non-serving cell meet the at least one quality requirement, responding the non-serving cell paging message on the non-serving cell (e.g., at step 308 in FIG. 3a).

In an embodiment (e.g., 300a in FIG. 3a), the multi-paging procedure may further comprise: if the one or more signal quality values of the non-serving cell do not meet the at least one quality requirement, sending a notifying message (e.g., at step 310 in FIG. 3a).

In an embodiment (e.g., 300a in FIG. 3a), the notifying message may be a registration request, a tracking area update (TAU), a location update (LU), or a radio area update (RAU).

In an embodiment (e.g., 300a or 300b in FIG. 3a or 3b), the non-serving cell may be a last seen cell.

In an embodiment (e.g., 300a or 300b in FIG. 3a or 3b), the non-serving cell may be a neighboring cell of the serving cell.

In an embodiment (e.g., 300a or 300b in FIG. 3a or 3b), the non-serving cell may be selected from at least one neighboring cell according to one or more signal quality values of the at least one neighboring cell.

In an embodiment (e.g., 200a in FIG. 2a), the method may further comprise: before the multi-paging procedure, comparing whether one or more signal quality values of the non-serving cell meet at least one quality requirement (e.g., at step 203 in FIG. 2a); if the one or more signal quality values of the non-serving cell meet the at least one quality requirement, enabling the multi-paging procedure (e.g., at step 205 in FIG. 2a).

In an embodiment (e.g., 200a in FIG. 2a), the method may further comprise: if the one or more signal quality values of the non-serving cell do not meet the at least one quality requirement, comparing whether one or more signal quality values of the serving cell meet the at least one quality requirement (e.g., at step 207 in FIG. 2a) before the multi-paging procedure.

In an embodiment (e.g., 200a in FIG. 2a), the method may further comprise: if the one or more signal quality values of the serving cell do not meet the at least one quality requirement, enabling the multi-paging procedure.

In an embodiment, (e.g., 200a in FIG. 2a), the method may further comprise: if the one or more signal quality values of the serving cell meet the at least one quality requirement, disabling the multi-paging procedure (e.g., at step 209 in FIG. 2a).

In an embodiment, (e.g., 200c in FIG. 2c), the method may further comprise: before the multi-paging procedure, determining whether to enable the multi-paging procedure (e.g., at step 204) according to one or more of the following: whether one or more applications or services currently executed by the UE are time-critical, whether the UE is a product of a predefine type, and a moving status of the UE.

In an embodiment (e.g., 300b in FIG. 3b), the multi-paging procedure may further comprise: if the non-serving cell paging message is received on the non-serving cell, comparing whether one or more signal quality values of the non-serving cell meets at least one quality requirement (e.g., at step 306 in FIG. 3b); and, if the one or more signal quality values of the non-serving cell meet the at least one quality requirement, responding the non-serving cell paging message on the non-serving cell (e.g., at step 308 in FIG. 3b).

An aspect of the invention is providing a method (e.g., 200a, 200b or 200c in FIG. 2a, 2b or 2c) for multi-paging of a UE (e.g., 100 in FIG. 1) in a network (e.g., 10 in FIG. 1). The network may be a wireless cellular network, and may comprise a plurality of cells (e.g., c1 to c3 in FIG. 1). The method may be executed by the UE, and may comprise a multi-paging procedure (e.g., 300a or 300b in FIG. 3a or 3b). The multi-paging procedure may comprise: when the UE camps on a serving cell (e.g., c2 in FIG. 1) of the plurality of cells, responding a non-serving cell paging message received on a non-serving cell (e.g., c1 in FIG. 1) of the plurality of cells (e.g., at step 308 in FIGS. 3a and 3b), wherein the non-serving cell is different from the serving cell.

In an embodiment, the multi-paging procedure may further comprise: before responding the non-serving cell paging message received on the non-serving cell, determining whether to respond the non-serving cell paging message according to whether one or more signal quality values of the non-serving cell meet at least one quality requirement (e.g., at step 306 in FIG. 3a or 3b).

An aspect of the invention is providing a UE which may operate according to the method of the invention.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 schematically depicts a UE in a network, and how the network starts a first paging attempt to communicatively reach the UE when the UE is no longer communicatively connected to the network;

FIGS. 2a to 2c depict flowcharts according to embodiments of the invention, wherein each of the flowcharts may include a multi-paging procedure;

each of FIGS. 3a and 3b depicts an embodiment of the multi-paging procedure in FIGS. 2a to 2c;

FIG. 4 depicts a waiting period shown in FIG. 3a; and

FIG. 5 depicts durations during which the UE may monitor paging messages.

### DETAILED DESCRIPTION OF PREFERRED EMBODIMENTS

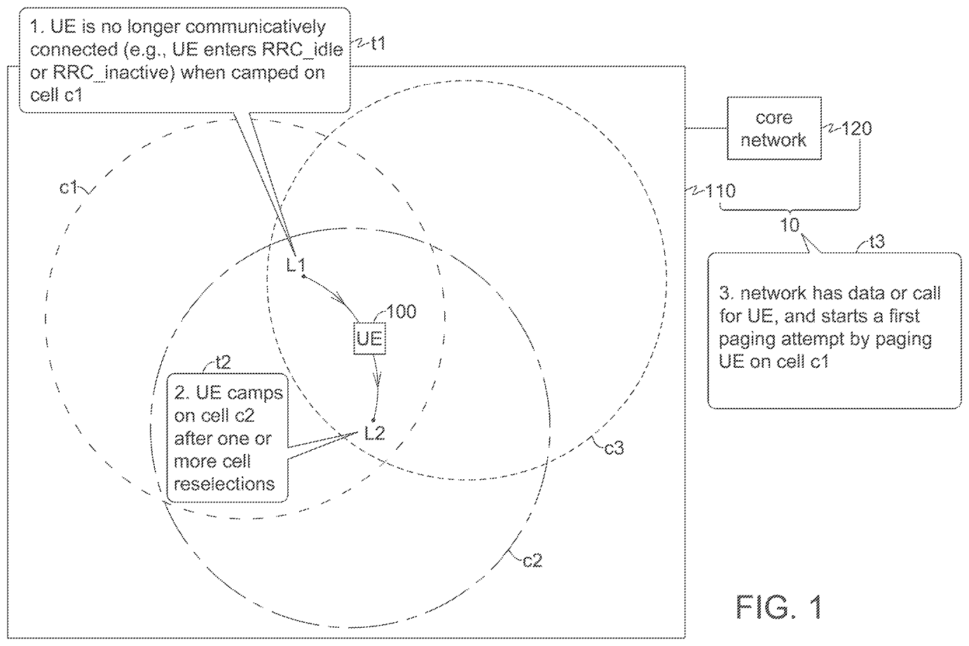

FIG. 1 schematically depicts a conceptual diagram regarding a UE 100 in a network 10 of wireless communication. The network 10 may be a wireless cellular network, and may include a radio access network (RAN) 110 and a core network 120. For example, the network 10 may be a network adopting one or more radio access technologies of mobile telecommunication, such as global system for mobile communications (GSM), universal mobile telecommunication system (UMTS), long-term evolution (LTE) and/or new radio (NR) specified by third generation partnership project (3GPP) and known as second, third, fourth and fifth generation (2G, 3G, 4G and 5G) telecommunication. The radio access network 110 may implement a GSM radio access network (GRAN), a GSM EDGE radio access network (GERAN, with EDGE representing enhanced data rates for GSM evolution), a UMTS terrestrial radio access network (UTRAN), an evolved UMTS terrestrial radio access network (E-UTRAN), and/or a next generation radio access network (NG-RAN). The radio access network 110 may form an air interface between the UE 100 and the core network 120, and may include a plurality of cells, such as cells c1, c2 and c3 shown in FIG. 1.

The UE 100 may be a mobile phone, or a telematics system for a vehicle (e.g., an automobile, a truck, etc.). The UE 100 may also be a tablet computer, a notebook computer, a laptop computer, a desktop computer, a wearable gadget (e.g., smart watch, ear phone or glasses, etc.), a drone, a digital camera, a digital camcorder, a set-top box, a smart speaker, a game console, a customer-premises equipment (CPE), a router, an access point, a home appliance (e.g., smart TV, air conditioner, lighting system, refrigerator, washing machine, etc.), an office equipment (e.g., copy machine, printer, audio or video conference system, surveillance system, etc.), an industrial equipment (e.g., assembly line robot), an internet-of-things (IoT) sensor or device, a navigator, or any electronics which implements functionality of wireless communication. The UE 100 may select one of the cells of the radio access network 110 as a serving cell to camp on the selected cell, may reselect another one of the cells of the radio access network 110 as a new serving cell to camp on the reselected cell, and may transmit user data to the core network 120 and/or receive user data from the core network 120 via the serving cell of the radio access network 110.

FIG. 1 also demonstrates an example of a usual scenario; in the scenario, at a time t0 and a location L1, when the UE 100 camps on the cell c1 as a serving cell and has stopped transmitting and receiving user data to and from the network 10 longer than a time threshold, the UE 100 may become communicatively unconnected to the network 10; e.g., the UE 100 may enter RRC_inactive or RRC_idle specified by 3GPP, with RRC representing radio resource control. Because the UE 100 turns to be communicatively unconnected to the network 10 when camping on the cell c1, the network 10 will recognize the cell c1 as a last seen cell of the UE 100.

After the time t1, the UE 100 may remain communicatively unconnected to the network 10, may move to different locations, and may reselect to camp on another cell. For example, at a time t2 after the time t1 and a location L2 different from the location 1, the UE 100 may camp on the cell c2 as the current serving cell after one or more cell reselections. At a time t3 following the time t2, when the UE 100 remains to camp on the cell c2, the network 10 starts a first paging attempt to page the UE 100. For example, the network 10 may start the first paging attempt when the radio access network 110 or the core network 120 needs to communicatively reach the UE 100, and/or, when the network 10 receives user data and/or incoming call targeting the UE 100. In some practical implementations, the network 10 will start the first paging attempt at the time t3 by causing the cell c1, instead of the cell c2, to send a paging message for paging the UE 100, because the cell c1 is the last seen cell of the UE 100 and the network 10 is unaware of that the UE 100 is currently camping on the cell c2.

At the time t3, while the network 10 only causes the last seen cell c1 to page the UE 100 for the first paging attempt, the UE 100 will not receive the paging message sent by the cell c1 if the UE 100 operates according to a conventional paging procedure. According to the conventional paging procedure, the UE 100 only monitors whether itself is paged by the current serving cell; thus, when the UE 100 camps on the cell c2 and the network 10 causes the cell c1 to page the UE 100 at the time t3, the UE 100 will not correctly receive the paging message on the cell c1, because the UE 100 adopting the conventional paging procedure only monitors whether message is received on the current serving cell c2, instead of the cell c1 which has become a non-serving cell for the UE 100 at the time t3. Therefore, if the UE 100 operates according to the conventional paging procedure, the UE 100 will not be able to receive and respond paging of the network 10 promptly at the first paging attempt, and will suffer from longer paging latency and/or higher paging miss rate.

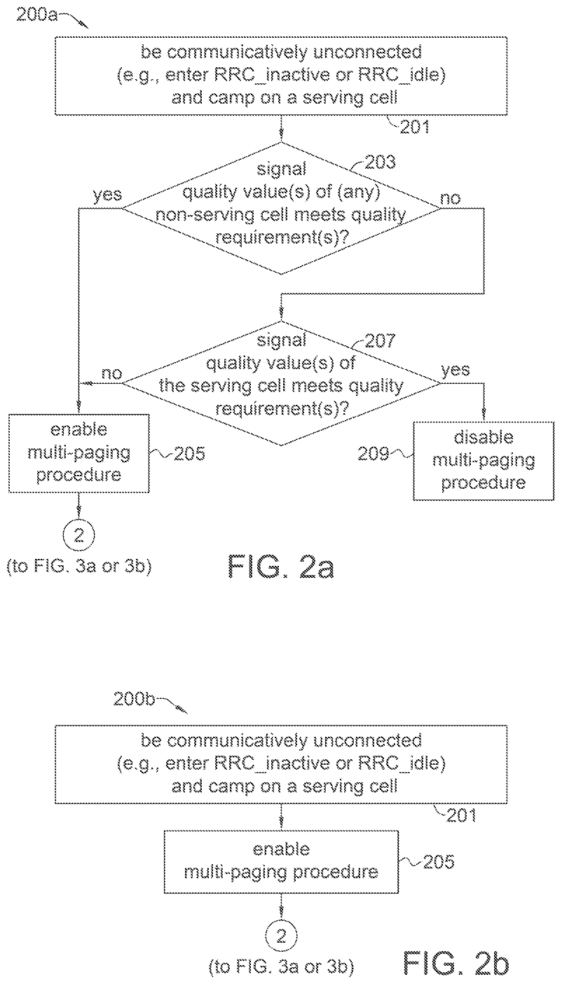

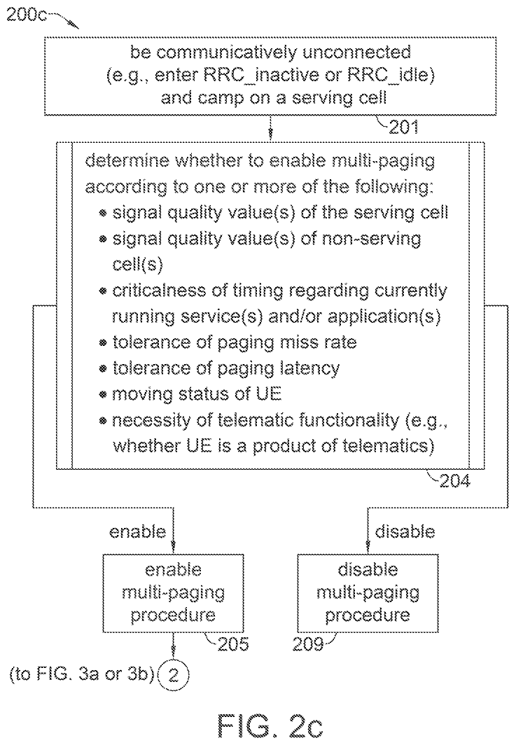

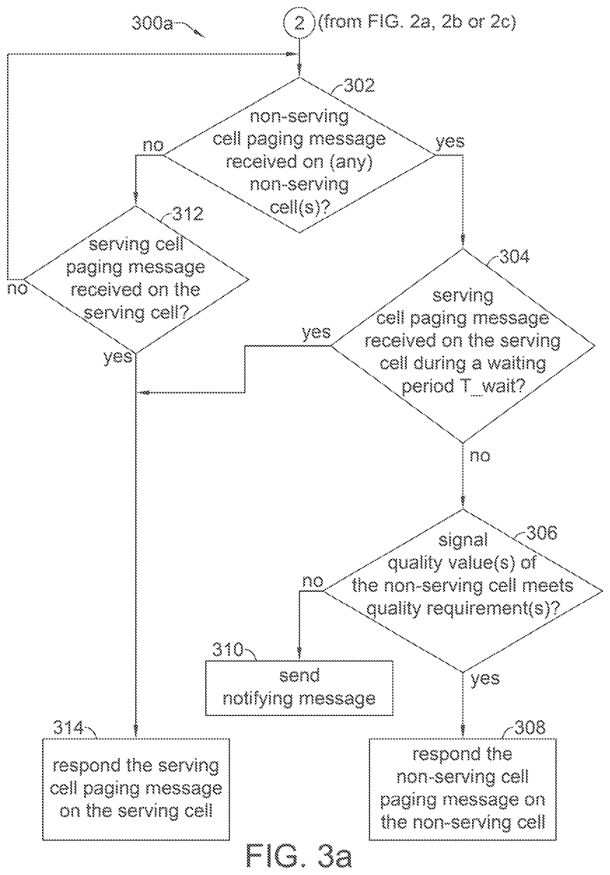

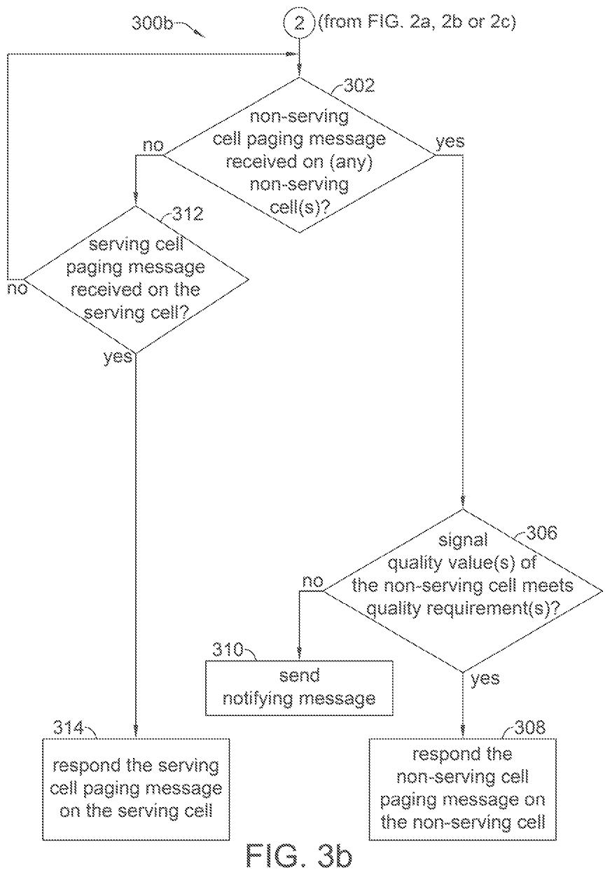

FIGS. 2a to 2c depict flowcharts 200a, 200b and 200c according to different embodiments of the invention, respectively. To overcome longer paging latency and/or higher paging miss rate resulting from the conventional paging procedure, the UE 100 (FIG. 1) may adopt the flowchart 200a, 200b or 200c when the UE 100 is communicatively unconnected to the network 10, e.g., when the UE 100 is in RRC_idle or RRC_inactive.

As shown in FIG. 2a, steps of the flowchart 200a may be described as follows.

Step 201: the UE 100 may start the flowchart 200a when the UE 100 starts to be communicatively unconnected to the network 10, e.g., when the UE 100 enters RRC_idle or RRC_inactive state.

Step 203: as the UE 100 is camping on a serving cell, the UE 100 may compare whether one or more signal quality values of any non-serving cell meet at least one quality requirement, may proceed to step 205 if the one or more signal quality values of one or more non-serving cells meet the quality requirement(s), and may proceed to step 207 if the one or more signal quality values of any non-serving cell does not meet the quality requirement(s). The non-serving cell(s) may be cell(s) other than the serving cell, e.g., may be or may include a last seen cell of the UE 100, and/or a qualified subset (none, one, some or all) of neighboring cell(s) of the current serving cell. The last seen cell of the UE 100 may be the cell which the UE 100 camps on when the UE 100 turns to be communicatively unconnected to the network 10, e.g., when the UE 100 starts to enter RRC idle state or RRC inactive state. The qualified subset of the neighboring cell(s) may be selected from the neighboring cell(s) of the current serving cell according to one or more signal quality values of each neighboring cell; for example, a certain neighboring cell of the current serving cell may be selected as one of the qualified subset of the neighboring cell(s) if the one or more signal quality values of the certain neighboring cell meet at least one predefined quality requirement.

As each cell may broadcast one or more its own informing signals to advertise information of itself, the one or more signal quality values of a non-serving cell may relate to strength and/or power of the informing signal(s) of the non-serving cell received and measured by the UE 100. For example, the informing signal(s) may be, or may include, synchronization signal (SS), cell specific reference signal (CRS) and/or channel state information (CSI) signal specified by 3GPP, etc.; the one or more signal quality values may be, may include, or may relate to, received signal strength indication (RSSI), reference signal received power (RSRP) and/or reference signal received quality (RSRQ) specified by 3GPP, etc. Each quality requirement may demand the one or more signal quality values, alone or in combination, to exceed one or more associated quality thresholds.

Step 205: the UE 100 may enable a multi-paging procedure according to the invention, and may execute the multi-paging procedure by proceeding to steps shown in FIG. 3a or 3b which will be described in detail later.

Step 207: the UE 100 may compare whether one or more signal quality values of the current serving cell meet the at least one quality requirement, may proceed to step 209 if the one or more signal quality values of the serving cells meet the quality requirement(s), and may proceed to step 205 if the one or more signal quality values of the serving cell do not meet the quality requirement(s). The one or more signal quality values of the serving cell may relate to strength and/or power of informing signal(s) of the serving cell received and measured by the UE 100. For example, the informing signal(s) may be, or may include, SS, CRS and/or CSI signal, etc.; the one or more signal quality values may be, may include, or may relate to, RSSI, RSRP and/or RSRQ, etc.

Step 209: the UE 100 may disable the multi-paging procedure. For example, the UE 100 may only monitor (e.g., periodically) whether the current serving cell pages the UE 100.

In an embodiment, the UE 100 may iterate step 203 periodically or aperiodically (e.g., whenever the UE 100 reselects a new serving cell) to dynamically and adaptively determine whether to enable the multi-paging procedure at step 205.

As shown in FIG. 2b, steps of the flowchart 200b may be described as follows. At step 201, the UE 100 may start the flowchart 200b when the UE 100 starts to communicatively disconnect with the network 10, e.g., when the UE 100 transits to RRC_idle or RRC_inactive state. At step 205, the UE 100 may enable the multi-paging procedure according to the invention, and may execute the multi-paging procedure by proceeding to steps shown in FIG. 3a or 3b. In an embodiment, between steps 201 and 205, the UE 100 may still compare whether the one or more signal quality values of the serving cell and/or the non-serving cell(s) meet associated quality requirement(s) similar to step 203 and/or step 207 shown in FIG. 2a, but may enable the multi-paging procedure at step 205 regardless of whether the one or more signal quality values of the serving cell and/or the non-serving cell(s) meet the associated quality requirement(s).

As shown in FIG. 2c, steps of the flowchart 200c may be described as follows. At step 201, the UE 100 may start the flowchart 200c after the UE 100 communicatively disconnect with the network 10, e.g., when the UE 100 turns to be RRC_idle or RRC_inactive. At step 204, according to one or more of decision factors, the UE 100 may determine whether to enable or disable the multi-paging procedure of the invention by proceeding to step 205 or 209 respectively. At step 205, the UE 100 may enable the multi-paging procedure, and may proceed to steps shown in FIG. 3a or 3b. At step 209, the UE 100 may disable the multi-paging procedure; for example, the UE 100 may only repeatedly check whether the current serving cell pages the UE 100. In an embodiment, the UE 100 may iterate step 204 periodically and/or aperiodically to dynamically and adaptively determine whether to enable the multi-paging procedure.

The decision factors considered at step 204 may include signal quality value(s) of the serving cell, signal quality value(s) of the non-serving cell(s), criticalness of timing regarding currently running service(s) and/or application(s) (e.g., whether one or more applications and/or one or more services currently executed by the UE 100 are time-critical), tolerance of paging miss rate, tolerance of paging latency, moving status of the UE 100, and/or necessity of telematic functionality (e.g., whether the UE 100 is a product of telematics), etc. For example, at step 204, when the UE 100 is running one or more service(s) and/or application(s) which is/are timing-critical, tolerance of paging miss rate is low, tolerance of paging latency is low, the UE 100 is moving fast, the UE 100 is moving in a way which causes frequent cell reselections, the UE 100 needs to implement telematic functionality, and/or the UE 100 itself is a telematics system, the UE 100 may decide to enable the multi-paging procedure of the invention by proceeding to step 205.

FIGS. 3a and 3b depict procedures 300a and 300b according to different embodiments of the invention, respectively. Continuing step 205 shown in FIG. 2a, 2b or 2c, the UE 100 may execute the procedure 300a or 300b in FIG. 3a or 3b to implement the multi-page procedure enabled at step 205.

As shown in FIG. 3a, the procedure 300a may include steps described as follows.

Step 302: the UE 100 may check whether any non-serving cell paging message is received on any non-serving cell of the network 10 (FIG. 1), wherein a non-serving cell paging message may be a paging message sent by a non-serving cell other than the current serving cell. If the UE 100 receives a non-serving cell paging message on a non-serving cell, the UE 100 may proceed to step 304; on the other hand, if the UE 100 does not receive any non-serving cell paging message on any non-serving cell, the UE 100 may proceed to step 312.

Step 304: the UE 100 may start to wait for a waiting period T_wait, and may check whether a serving-cell paging message is received on the current serving cell when waiting, wherein the serving cell paging message may be a paging message sent by the current serving cell. When waiting the waiting period T_wait to elapse, if the UE 100 receives a serving cell paging message on the serving cell, the UE 100 may proceed to step 314. On the other hand, if the UE 100 does not receive any serving cell paging message on the serving cell when the waiting period T_wait ends, the UE 100 may proceed to step 306.

Step 306: the UE 100 may compare whether one or more signal quality values of the non-serving cell, which sends the non-serving cell paging message received at step 302, meet at least one quality requirement. If the one or more signal quality values of the non-serving cell meet the quality requirement(s), the UE 100 may proceed to step 308; otherwise, the UE 100 may proceed to step 310.

The one or more signal quality values of the non-serving cell may relate to strength and/or power of the informing signal(s) of the non-serving cell received and measured by the UE 100. For example, the informing signal(s) may be, or may include, SS, CRS and/or CSI, etc.; the one or more signal quality values may be, may include, or may relate to, RSSI, RSRP and/or RSRQ, etc. Each quality requirement may demand one or more signal quality values, alone or in combination, to exceed one or more associated quality thresholds.

Step 308: the UE 100 may respond the non-serving cell paging message, which is received at step 302, on the non-serving cell which sends the non-serving cell paging message; the UE 100 may therefore become communicatively connected to the network 10.

Step 310: the UE 100 may send a notifying message to the network 10. In an embodiment, the notifying message may be a message requesting registration and/or mobility update; for example, the notifying message may be a registration request for 5G telecommunication, a tracking area update (TAU) for 4G telecommunication, a location update (LU) for 3G telecommunication, or a radio area update (RAU) for 2G telecommunication.

Step 312: following step 302, the UE 100 may check whether any serving cell paging message is received on the current serving cell of the network 10 (FIG. 1). If the UE 100 receives a serving cell paging message on the serving cell, the UE 100 may proceed to step 314; on the other hand, if the UE 100 does not receive any serving cell paging message on the serving cell, the UE 100 may iterate back to step 302.

Step 314: the UE 100 may respond the serving cell paging message received at step 312 on the current serving cell, and may therefore become communicatively connected to the network 10.

While a UE operating according to the conventional paging procedure only checks and responds serving cell paging message sent on current serving cell, the UE 100 operating according to the multi-paging procedure 300a of the invention may not only check (steps 304 and 312) and respond (step 314) serving cell paging message on the serving cell, but may further check (step 302) and respond (steps 308) non-serving cell paging message on non-serving cell if the UE 100 does not receive any serving cell paging message on the current serving cell. Thus, when the UE 100 operates according to the procedure 300a of the invention, the UE 100 may promptly receive and respond the first paging attempt of the network 10 (FIG. 1) even if the network 10 only pages the UE 100 on non-serving cell(s) other than the current serving cell at the first paging attempt, and may therefore effectively shorten paging latency and/or lower paging miss rate.

As shown in FIG. 3b, the procedure 300b may be similar to the procedure 300a (FIG. 3a); the procedure 300b may include steps 302, 306, 308, 310, 312 and 314 also included in the procedure 300a, but the procedure 300b may skip step 304 existed in the procedure 300a. That is, when the UE 100 operates according to the procedure 300b, the UE 100 may proceed to step 306, without checking whether serving cell paging messaged is received during the waiting period T_wait (FIG. 3a), after the UE 100 receives a non-serving cell paging message on a non-serving cell at step 302. Also similar to the procedure 300a, when operating according to the procedure 300b, the UE 100 may check (step 302) and respond (step 308) non-serving cell paging message on non-serving cell in addition to checking (step 312) and responding (step 314) serving cell paging message on serving cell. Thus, when the UE 100 operates according to the procedure 300b of the invention, the UE 100 may promptly receive and respond the first paging attempt of the network 10 even if the network 10 only pages the UE 100 on non-serving cell(s) other than the current serving cell at the first paging attempt, and may therefore effectively shorten paging latency and/or lower paging miss rate.

Briefly speaking, when the UE 100 operates according to the invention, the UE 100 may check whether any non-serving cell paging message is received on one or more non-serving cell; if a non-serving cell paging messaged is received on a non-serving cell, the UE 100 may determine whether to respond the non-serving cell paging message according to whether a serving-cell paging message is received on the serving cell during the waiting period T_wait (step 304 in FIG. 3a) after receiving the non-serving cell paging message, and/or, whether one or more signal quality values of the non-serving cell meet at least one quality requirement (step 306 in FIGS. 3a and 3b). In an embodiment, the UE 100 may dynamically and adaptively select to adopt one of the procedures 300a and 300b according to one or more selection conditions, e.g., whether the UE 100 has redundancy and/or necessity to monitor serving cell paging message during the waiting period T_wait.

Continuing the example of the scenario demonstrated in FIG. 1, the UE 100 operating according to the invention may start the flowchart 200a, 200b or 200c in FIG. 2a, 2b or 2c at the time t1; assuming that the UE 100 has enabled the multi-paging procedure 300a or 300b in FIG. 3a or 3b at step 205 after the UE 100 camps on the cell c2 at the time t2, then the UE 100 may, by executing step 302 (FIG. 3a or 3b), promptly receive the non-serving cell paging message on the non-serving cell c1 at the time t3 when the network 10 starts the first paging attempt, and may therefore overcome long paging latency and/or high paging miss rate.

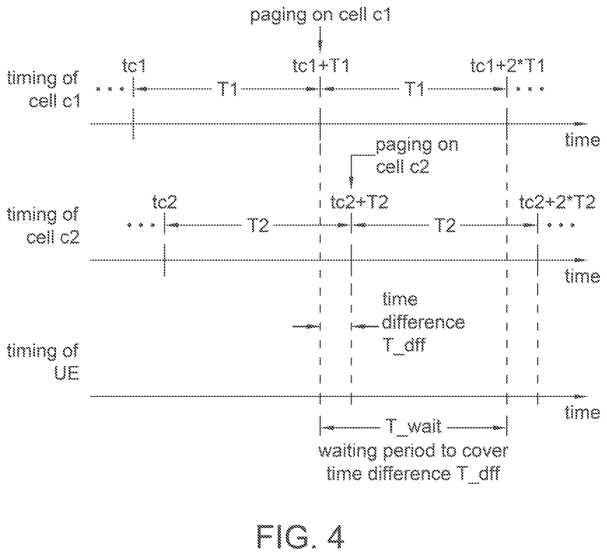

FIG. 4 depicts the waiting period T_wait utilized at step 304 of the procedure 300a shown in FIG. 3a. Continuing the example of the scenario shown in FIG. 1, timing allocated for the cell c1 to send paging message may repeat at a period T1 around a time tc1; that is, if the cell c1 needs to page the UE 100, the cell c1 may send a paging message at times tc1, tc1+T1, and/or tc1+2*T1, etc. On the other hand, timing allocated for the cell c2 to send paging message may repeat at a period T2 around a time tc2, i.e., if the cell c2 needs to page the UE 100, the cell c2 may send a paging message at times tc2, tc2+T2, or tc2+2*T2, etc. In an embodiment, the period T1 may be a discontinuous reception (DRX) cycle of the cell c1, and the period T2 may be a DRX cycle of the cell c2.

As shown in FIG. 4, there may possibly exist a time difference T_dff between the times tc1 and tc2. When the UE 100 operates according to the procedure 300a (FIG. 3a) and camps on the cell c2 as the current serving cell (e.g., after the time t2 in FIG. 1), if the UE 100 receives a non-serving cell paging message on the non-serving cell c1 at step 302 (FIG. 3a), the UE 100 may set a length of the waiting period T_wait, which is to be utilized at step 304 (FIG. 3a), to cover the time difference T_dff. Because the time-difference T_dff may possibly extend as long as the period T1 and/or the period T2, the UE 100 may set the waiting period T_wait according to the period(s) T1 and/or T2. For example, in an embodiment, the UE 100 may set the waiting period T_wait not to be shorter than the period T2 of the current serving cell c2; in another embodiment, the UE 100 may set the waiting period T_wait not to be shorter than the period T2 of the serving cell c2 and the period T1 of the non-serving cell c1, i.e., the UE 100 may set the waiting period T_wait not to be shorter than a maximum of the periods T1 and T2. The periods T1 and T2 may be equal or different.

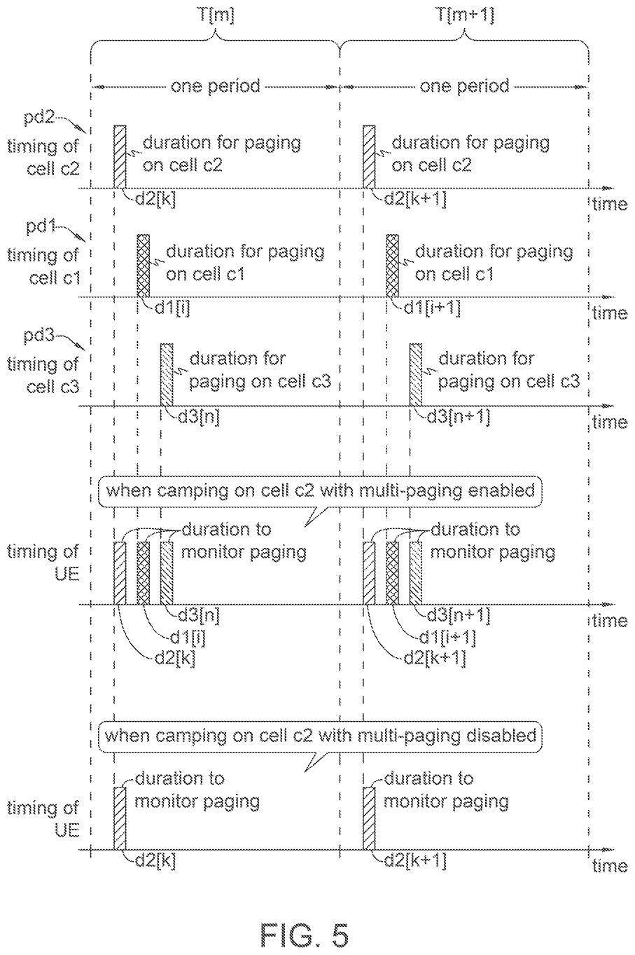

FIG. 5 depicts durations for the UE 100 to check (monitor) paging message at step 302, step 304 (FIGS. 3a and 3b) and step 304 (FIG. 3a) when the UE 100 operates according to the procedure 300a or 300b (FIG. 3a or 3b). As shown in FIG. 5, continuing the example of the scenario shown in FIG. 1, the cell c2 may allocate a paging duration series pd2, which may include a plural of periodic durations respectively in a plurality periods, such as durations d2[k] and d2[k+1] respectively in periods T[m] and T[m+1], to send paging message; that is, if the cell c2 needs to page the UE 100, the cell c2 may send a paging message during one (or each) of the paging duration series pd1, e.g., during the duration d2[k] or d2[k+1] in the period T[m] or T[m+1]. Similarly, the cell c1 may allocate a paging duration series pd1, which may include a plurality of periodic durations respectively in the plurality of periods, such as durations d1[i] and d1[i+1] in the periods T[m] and T[m+1], to send paging message, and the cell c3 may allocate a paging duration series pd3, which may include a plurality of periodic durations respectively in the plurality of periods, such as durations d3[n] and d3[n+1] in the periods T[m] and T[m+1], to send paging message.

If the UE 100 operates according to the invention and enables the multi-paging procedure at step 205 (FIGS. 2a, 2b and 2c) after the time t1 (FIG. 1), the UE 100 may execute steps 302, 304 and 312 (FIGS. 3a and 3b) by enabling wireless receiving during the durations of the paging duration series pd1, pd2 and pd3 to check if paging message is received on the cell c1, c2 and c3, respectively. For example, when the UE 100 camps on the cell c2 after the time t2, the UE 100 may enable wireless receiving during the durations of the paging duration series pd1 and pd3 (e.g., during the durations d1[i] and d3[n] in each period T[m]) to execute step 302 (FIGS. 3a and 3b) by checking if any non-serving cell paging message is received on the non-serving cells c1 and c3; the UE 100 may also enable wireless receiving during the durations of the paging duration series pd2 (e.g., during the duration d2[k] in each period T[m]) to execute step 312 (FIGS. 3a and 3b) and step 304 (FIG. 3a) by checking if any serving cell paging message is received on the current serving cell c2. The UE 100 may disable wireless receiving for lowering power consumption at times other than the durations of the paging duration series pd1, pd2 and pd3.

If the UE 100 operates according to the invention and disables the multi-paging procedure at step 209 (FIGS. 2a and 2c) after the time t1 (FIG. 1), the UE 100 may enable wireless receiving during the durations of the paging duration series pd1 and pd2 respectively when camping on the cells c1 and c2, and may thereby check if serving cell paging message is received on the current serving cell. That is, when the UE 100 camps on the cell c1 between the times t1 and t2, the UE 100 may enable wireless receiving during the durations of the paging duration series pd1 (e.g., during each duration d1[i] in each period T[m]) to checking if any paging message is received on the current serving cell c1; when the UE 100 camps on the cell c2 after the time t2, the UE 100 may enable wireless receiving during the durations of the paging duration series pd2 (e.g., during each duration d2[k] in each period T[m]) to check if any paging message is received on the current serving cell c2. At times other than the durations included in the paging duration series of the current serving cell, the UE 100 may disable wireless receiving for lowering power consumption.

In other embodiments not depicted, the UE 100 operating according to the invention may respectively monitor different subsets of the cells in different periods when the UE 100 enables the multi-paging procedure 300a or 300b. For example, in an embodiment, when the UE 100 camps on the cell c2, the UE 100 may enable wireless receiving during one of the paging duration series pd1 and one of the paging duration series pd2 to monitor paging on the cells c1 and c2 in a first period of every two periods, and may enable wireless receiving during another one of the paging duration series pd2 and one of the paging duration series pd3 to monitor paging on the cells c2 and c3 in a second period of every two periods; e.g., the UE 100 may monitor paging on the cells c2 and c1 during two durations d2[2*k′−1] and d1[2*i′−1] in each period T[2*m′−1], and may monitor paging on the cells c2 and c3 during two duration d2[2*k′] and d3[2*n′] in each period T[2*m]. In another embodiment, the UE 100 may enable wireless receiving during one of the paging duration series pd2, one of the paging duration series pd1 and one of the paging duration series pd3 respectively in a first period, a second period and a third period of every three periods; e.g., the UE 100 may monitor paging on the cell c2 during each duration d2[3*k′−2] in each period T[3*m′−2], may monitor paging on the cell c1 during each duration d1[3*i′−1] in each period T[3*m′−1], and may monitor paging on the cell c3 during each duration d3[3*n′] in each period T[3*m′].

To sum up, in a wireless cellular network which sends paging message to page a communicatively unconnected UE only on a last seen cell of the UE at a first paging attempt, assuming that the UE has reselected to camp on a serving cell other than the last seen cell, the UE will fail to receive the first paging attempt if the UE operates according to conventional paging procedure which only monitors paging on the serving cell; on the other hand, the UE may promptly receive the first paging attempt if the UE operates according to the invention which may monitor (and respond, if appropriate) paging on one or more non-serving cells besides the serving cell. Hence, the UE operating according to the invention may effectively reduce paging latency and paging miss rate.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for multi-paging of a user equipment (UE) in a network; the network being a wireless cellular network and comprising a plurality of cells; the method being executed by the UE, and comprising a multi-paging procedure; the multi-paging procedure comprising:
when the UE camps on a serving cell of the plurality of cells, checking whether a non-serving cell paging message is received on a non-serving cell of the plurality of cells, with the non-serving cell being different from the serving cell.

2. The method of claim 1, wherein the multi-paging procedure further comprises:
if the non-serving cell paging message is received on the non-serving cell, checking whether a serving-cell paging message is received on the serving cell.

3. The method of claim 2, wherein:
when checking whether the serving-cell paging message is received on the serving cell, checking whether the serving-cell paging message is received on the serving cell during a waiting period.

4. The method of claim 3, wherein the waiting period is not shorter than a discontinuous reception (DRX) cycle of the serving cell.

5. The method of claim 3, wherein the waiting period is not shorter than a DRX cycle of the serving cell and a DRX cycle of the non-serving cell.

6. The method of claim 2, wherein the multi-paging procedure further comprises:
if the serving-cell paging message is received on the serving cell, responding the serving-cell paging message on the serving cell.

7. The method of claim 2, wherein the multi-paging procedure further comprises:
if the serving-cell paging is not received on the serving cell, comparing whether one or more signal quality values of the non-serving cell meets at least one quality requirement; and
if the one or more signal quality values of the non-serving cell meet the at least one quality requirement, responding the noni-serving cell paging message on the non-serving cell.

8. The method of claim 7, wherein the multi-paging procedure further comprises:
if the one or more signal quality values of the non-serving cell do not meet the at least one quality requirement, sending a notifying message.

9. The method of claim 8, wherein:
the notifying message is a registration request, a tracking area update (TAU), a location update (LU), or a radio area update (RAU).

10. The method of claim 1, wherein the non-serving cell is a last seen cell.

11. The method of claim 1, wherein:
the non-serving cell is a neighboring cell of the serving cell.

12. The method of claim 1, wherein the non-serving cell is selected from at least one neighboring cell according to one or more signal quality values of the at least one neighboring cell.

13. The method of claim 1 further comprising:
before the multi-paging procedure, comparing whether one or more signal quality values of the non-serving cell meet at least one quality requirement; and
if the one or more signal quality values of the non-serving cell meet the at least one quality requirement, enabling the multi-paging procedure.

14. The method of claim 13 further comprising:
if the one or more signal quality values of the non-serving cell do not meet the at least one quality requirement, comparing whether one or more signal quality values of the serving cell meet the at least one quality requirement before the multi-paging procedure.

15. The method of claim 14 further comprising:
if the one or more signal quality values of the serving cell do not meet the at least one quality requirement, enabling the multi-paging procedure.

16. The method of claim 15 further comprising:
if the one or more signal quality values of the serving cell meet the at least one quality requirement, disabling the multi-paging procedure.

17. The method of claim 1 further comprising:
before the multi-paging procedure, determining whether to enable the multi-paging procedure according to one or more of the following:
whether one or more applications or services currently executed by the UE are time-critical;
whether the UE is a product of a predefine type; and
a moving status of the UE.

18. The method of claim 1, wherein the multi-paging procedure further comprises:
if the non-serving cell paging message is received on the non-serving cell, comparing whether one or more signal quality values of the non-serving cell meets at least one quality requirement; and
if the one or more signal quality values of the non-serving cell meet the at least one quality requirement, responding the non-serving cell paging message on the non-serving cell.

19. A method for multi-paging of a user equipment (UE) in a network; the network being a wireless cellular network and comprising a plurality of cells; the method being executed by the UE, and comprising a multi-paging procedure; the multi-paging procedure comprising:
when the UE camps on a serving cell of the plurality of cells, responding a non-serving cell paging message received on a non-serving cell of the plurality of cells, wherein the non-serving cell is different from the serving cell.

20. The method of claim 19, wherein the multi-paging procedure further comprises:
before responding the non-serving cell paging message received on the non-serving cell, determining whether to respond the non-serving cell paging message according to whether one or more signal quality values of the non-serving cell meet at least one quality requirement.
